(19) United States
(12) Patent Application Publication
(10) Pub. No.: US 2007/0214020 A1
(43) Pub. Date: Sep. 13, 2007

(54) Modeling of insurance product data

(76) Inventors: Balaji Srinivasan, Sunnyvale, CA (US); Shan Wei, Palo Alto, CA (US); Ashfaq Jeelani, San Jose, CA (US); Lin Lee, Fremont, CA (US); Caroline Muralitharan, San Jose, CA (US)

Correspondence Address: CSA LLP, 4807 SPICEWOOD SPRINGS RD., BLDG. 4, SUITE 201, AUSTIN, TX, 78759, US

(21) Appl. No.: 10/392,133

(22) Filed: Mar. 18, 2003

(51) Int. Cl. G06F 17/30; G06Q 40/00

(52) U.S. Cl. 705/4; 707/1

(57) ABSTRACT

An insurance product class is defined which includes multiple data elements that are common to various insurance product types. Further, several classes derived from the insurance product class are defined, with each derived class extending the common data elements to include data elements that are specific to a certain insurance product type.

### FIELD OF THE INVENTION

This invention relates generally to data modeling, and more particularly to modeling of insurance product data.

### COPYRIGHT NOTICE/PERMISSION

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright© 2001, Siebel Systems, Inc., All Rights Reserved.

### BACKGROUND OF THE INVENTION

Various insurance companies and agencies store information electronically in furtherance of their business needs. Typically, individual insurance companies and agencies store insurance related information in their own unique way. For example, a life insurance provider may organize policy related information in a way that is very different from the way that an automobile insurance provider may organize policy related information. Even within a single insurance company, that company may use many different application programs that employ very different schemas and data models. For example, an underwriting program may use a data model that is very different from the data model used by an accounting program. The use of customized data models by an insurance company or agency and by internal applications has the advantage that it allows information to be modeled in a way that is appropriate for the business needs of the insurance company or agency. Unfortunately, because of this diversity in the data models, it is not easy for the insurance company to share its information with insurance agencies or other companies or for internal applications to share their information.

Various attempts have been made to define standard data models so that information can be more easily shared between insurance organizations and applications. However, these data models have not been able to achieve sufficient data integration and simplicity. As a result, insurance companies and agencies have to maintain, support and upgrade multiple different data structures and maps for their products.

### SUMMARY OF THE INVENTION

The present invention relates to various aspects for modeling insurance product data.

According to one aspect of the present invention, an insurance product class is defined which includes multiple data elements that are common to various insurance product types. Further, several classes derived from the insurance product class are defined, with each derived class extending the common data elements to include data elements that are specific to a certain insurance product type.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a block diagram illustrating the interconnection between various business systems and a universal business application network, according to one embodiment of the present invention.

FIG. 2 is a block diagram illustrating the overall architecture of a universal business application network, according to one embodiment of the present invention.

FIG. 3 is a flow diagram of one embodiment of a process for facilitating the sharing of insurance product data between two insurance applications.

FIG. 4 is a flow diagram of one embodiment of a process for adding custom data to an insurance product class.

FIGS. 5-11 illustrate one embodiment of a common data model representing a policy.

FIG. 12 is a block diagram of an exemplary computer system that may be used to perform one or more of the operations described herein.

### DETAILED DESCRIPTION OF THE INVENTION

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

A data model that provides a common data structure to represent an insurance product and allows for customization of the data model in a manner that facilitates upgrading of the data model is described. In one embodiment, the data model defines an insurance product class that includes a set of data elements that are common to various insurance product types. The various insurance product types may include an automobile insurance policy type, a life insurance policy type, a property insurance policy type, an insurance product quote (i.e., a quote for any insurance product type) type, or a type of any other product offered by an insurance company or agency. The insurance product class can be sub-classed (i.e., be a base class for a derived class) depending on the insurance product type. Each derived class includes the common data elements included in the insurance product class and a set of data elements that are specific to a certain insurance product type. For example, for the automobile insurance policy class, the specific data elements may include a list of vehicles associated with the policy, a list of coverages for each vehicle, a list of drivers associated with the policy and a list of coverages for each driver. In another example, the specific data elements of the life insurance policy class may include a list of holdings (e.g., properties or assets) associated with the policy, a list of coverages associated with the policies, and a list of policy beneficiaries and their roles.

In one embodiment, the insurance product class defines various relationships of an insurance product. These relationships may include relationships with related insurance products (e.g., other insurance policies of the same insured, insurance policies of a person related to this insured, etc.), relationships with parties participating in the insurance product (e.g., drivers, homeowners, benefactors, etc.), relationships with insurance product producers (e.g., insurance agents, underwriters, etc.), relationships with payment plans (e.g., an automatic monthly deduction from a bank account, etc.), etc. The data model models the relationships as attributes associated with an insurance product. In one embodiment, the data model is specified using a schema language such as XML Schema.

In one embodiment, the data model defines a hierarchy of the data elements for describing an insurance product. The data model may define data elements that are complex. A complex data element is a data element that comprises data sub-elements. For example, an address data element may be a complex data element that includes street, city, and state data sub-elements. The data model may specify custom data elements at various places within the hierarchy of data elements. A custom data element is of a custom data element type. The custom data element type initially defines no data elements. The data model can be customized by defining custom data elements that are specific to different applications or systems. For example, the data elements of the insurance product class may have a custom data element for a premium discount code, or the data elements of the automobile insurance policy class may have a custom data element for the date of the most recent incident of the insured. Because the custom data elements are defined at various places within the hierarchy, the customizations of the data model can be associated with related data elements within the hierarchy.

Accordingly, a common data model representing various insurance product types allows the insurance organizations to maintain, support and upgrade only a single data model and provides for efficient data transformations and mappings. In addition, the existence of custom data elements at various levels of the data model's hierarchy simplifies the customization of the common data model.

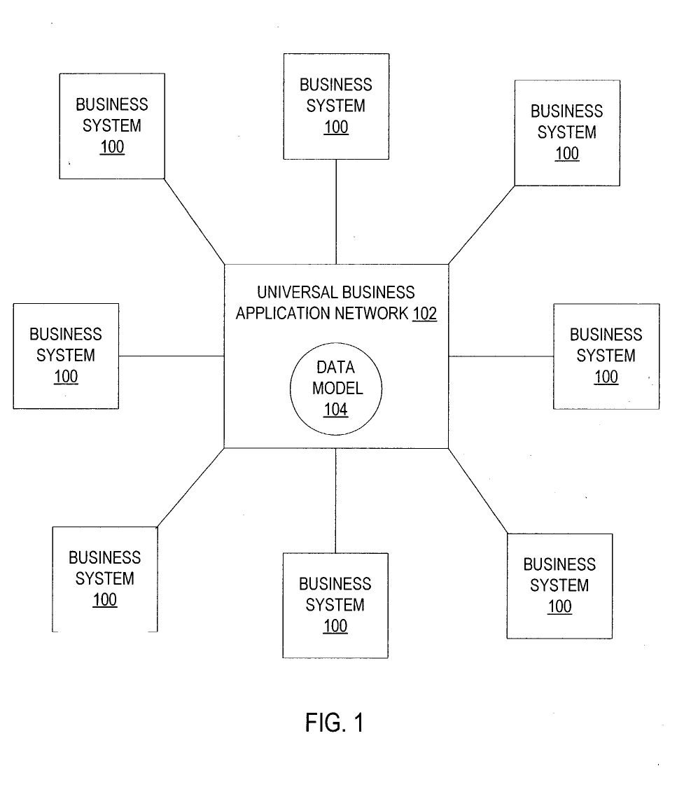

FIG. 1 is a block diagram illustrating the interconnection between various business systems 100 (e.g., insurance systems or other business systems utilizing insurance related data) and a universal business application network 102, according to one embodiment of the present invention. The universal business application network 100 serves as an integration hub for the business systems 100. The architecture of the universal business application network 102 allows new applications (e.g., new insurance applications) that access legacy business systems to be developed with minimum customization. The legacy business systems can be provided by a single business organization (e.g., an insurance company or agency) or by different business organizations. The universal business application network 102 allows the insurance applications to exchange information using a common insurance product data model 104.

In one embodiment, the common data model 104 defines a hierarchical data structure representing an insurance product. This hierarchical data structure includes data elements that are common to all business systems 100. In addition, the hierarchical data structure includes data custom data elements at various levels of the hierarchy to define data fields that are specific to each business system 100, thus providing for easy customization of the common data model 104.

In one embodiment, the universal business application network 102 uses the XML and Web services standards.

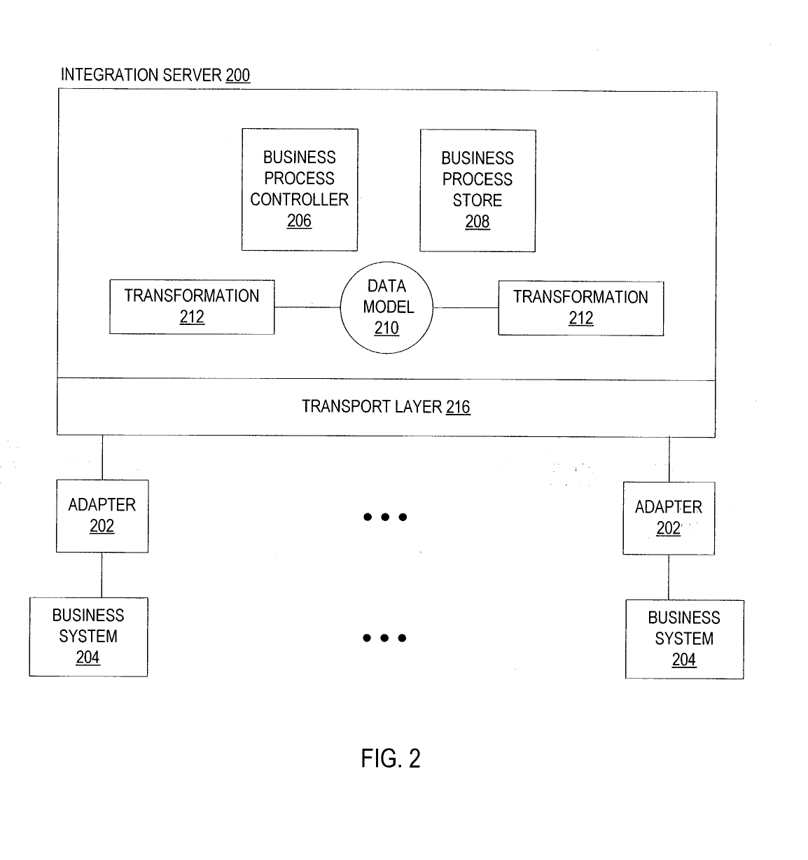

FIG. 2 is a block diagram illustrating the overall architecture of a universal business application network in one embodiment. The hub of the universal business application network is an integration server 200 that connects to the various business systems 204 (e.g., insurance systems or other business systems utilizing insurance related data) via adapters 202. The integration server 200 includes a transport layer 216, a data model 210, a transformation store 214, a business process controller 206, and a business process store 208.

The transport layer 216 is a mechanism through which business information is exchanged between the business systems 204 and the business integration server 200. Each business system 204 may have an adapter 202 that is appropriate to the protocol of the transport layer. For example, the transport mechanism may use communications protocols such as TCP/IP. The transport layer 216 may provide a messaging service for queuing, for guaranteeing delivery of messages, and for handling both synchronous and asynchronous messaging. The adapters 202 relay events from the business systems 204 to the integration server 200 and can import configurations of the business systems 204 into the integration server 200. In addition, the universal business application network may include encryption and authentication mechanisms to ensure the security and integrity of the information. For example, authentication will help ensure that a business process is accessing the intended business system, rather than an impostor business system.

The integration server 200 stores the representation of a data model 210 (e.g., in an XML schema file) that contains the definition of an insurance product class and the definitions of derived classes for various insurance product types such as an automobile insurance policy type, a life insurance policy type, a property insurance policy type, an insurance product quote type, etc.

The transformation store 212 contains a model data definition tool (e.g., an XML schema definition tool) to create a definition of the data model 210 (e.g., in an XML schema file) and to customize the data model 210 when requested by adding custom data fields to the data model 210. The transformation store 212 also contains transformations for transforming information received from the business systems 204 to the format used by the data model 210, and vice versa. For example, an automobile insurance policy class may include a globally unique identifier for each automobile insurance policy. A transformation for a business system that does not use globally unique identifiers may need to access an identification server to determine the globally unique identifier for each automobile insurance policy. The transformations may be specified as a computer program, an XML Stylesheet Language Transform (OXSL TO), etc.

The business process store 208 contains the business processes that have been defined. A business process may be specified as a script, a process flow, an executable program, etc. In one embodiment, the business processes are defined using the Web Services Flow Language (OOWSFL). The business processes orchestrate a sequence of steps across multiple applications provided by the business systems 204 to achieve a business objective.

The business process controller 206 coordinates the execution of the business processes. The business process controller 206 may instantiate derived classes and invoke functions of the resulting objects in accordance with the various business processes. The business process controller 206 may also initiate the execution of business processes based on predefined conditions and events. For example, the business process controller 206 may launch a certain business process each time an alert is received. Although not shown, the business integration network may provide a standard library of business routines that may be invoked by the business processes. For example, a standard business routine may identify whether two policy objects are related via participating parties and create a relationship between the two policy objects if they are related. The integration server 200 may also include various tools to facilitate the development of business processes. These tools may aid in the development of transformations, the defining of classes, and the writing of process flows.

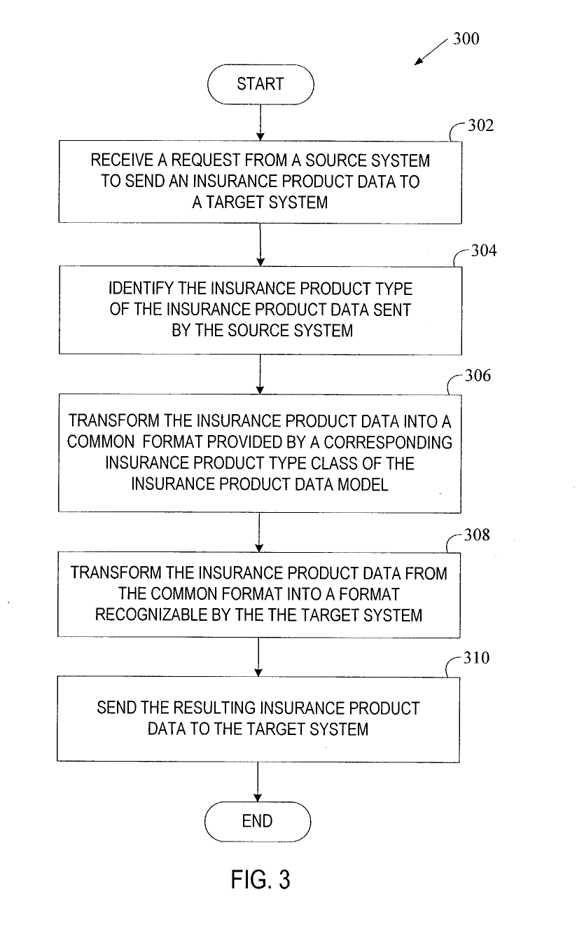

FIG. 3 is a flow diagram of one embodiment of a process 300 for facilitating the sharing of insurance product data between two insurance applications. The process may be performed by processing logic that may comprise hardware (e.g., circuitry, dedicated logic, etc.), software (such as run on a general purpose computer system or a dedicated machine), or a combination of both. Processing logic may reside on an integration server such as the integration server 200 of FIG. 2.

Referring to FIG. 3, process 300 begins with processing logic receiving a request from a source system to send an insurance product data to a target system (processing block 302). For example, insurance product data may be data associated with a new policy application, a source system may be a front-end application used by an insurance agent or an insurance company employee, and a target system may be an insurance company's rate engine for determining policy coverages.

Next, processing logic identifies the insurance product type of the insurance product data sent by the source system (processing block 304). The insurance product type may be the automobile insurance policy type, the life insurance policy type, the property insurance policy type, the insurance product quote type, etc.

At processing block 306, processing logic transforms the insurance product data into a common format provided by a corresponding insurance product type class of the insurance product data model. Insurance product type classes are derived from the insurance product class that includes data elements which are common to all insurance product types. The common data elements define relationships of the resulting insurance product object with other objects such as other insurance product objects, objects of parties participating in this insurance product, objects of producers of this insurance product, etc. In one embodiment, the relationships of the insured product object are created during the transformation based on information received from the source system. Alternatively, the relationships may be created by designated business processes (e.g., business processes stored in the business process store 208) after the transformation.

Further, processing logic transforms the insurance product data from the common format into a format recognizable by the target system (processing block 308) and sends the resulting insurance product data to the target system (processing block 310).

Thus, according to the process 300, the sharing of insurance product data between two insurance applications does not require data mapping between the data format of the source application and the data format of the target application. Instead, the mapping is performed between each insurance application and the common data model.

In one embodiment, each class of the insurance product data model can be customized for a specific business system or application.

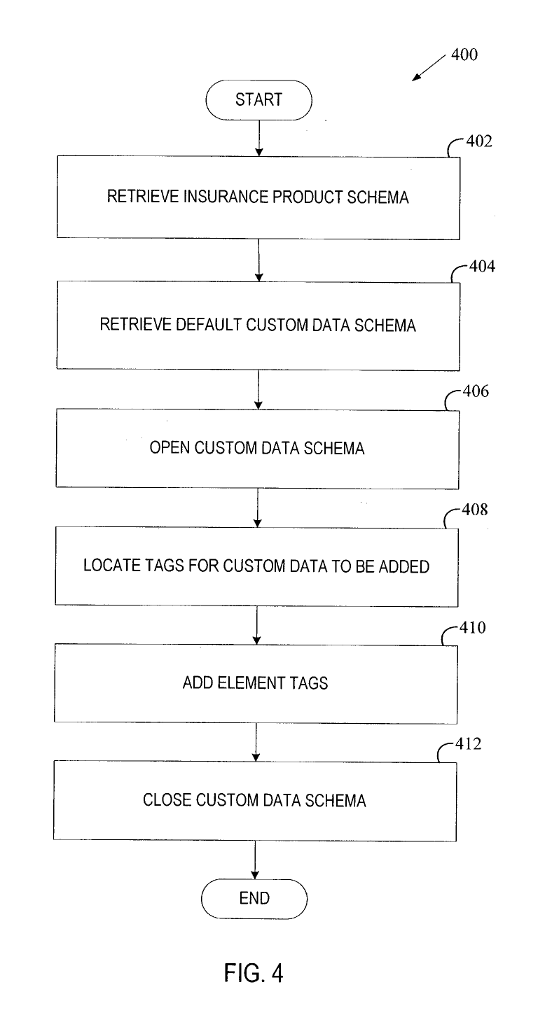

FIG. 4 is a flow diagram of one embodiment of a process for adding custom data to an insurance product class. The process may be performed by processing logic that may comprise hardware (e.g., circuitry, dedicated logic, etc.), software (such as run on a general purpose computer system or a dedicated machine), or a combination of both. Processing logic may reside on an integration server such as the integration server 200 of FIG. 2.

At processing block 402, processing logic retrieves a data definition schema for the insurance product class. The schema may be an XML schema file that include a custom data element of a type that is defined in another file.

At processing block 404, processing logic retrieves the custom data schema for the types of custom data. The schema may be stored in an XML schema file that contains the definition for each type of custom data.

Next, processing logic opens the custom data schema (processing block 406) and locates the tags relating to the custom data type of interest (processing block 408).

Further, processing logic adds the custom data elements to the located tags (processing block 410) and closes the custom data schema with the newly defined data elements (processing block 412).

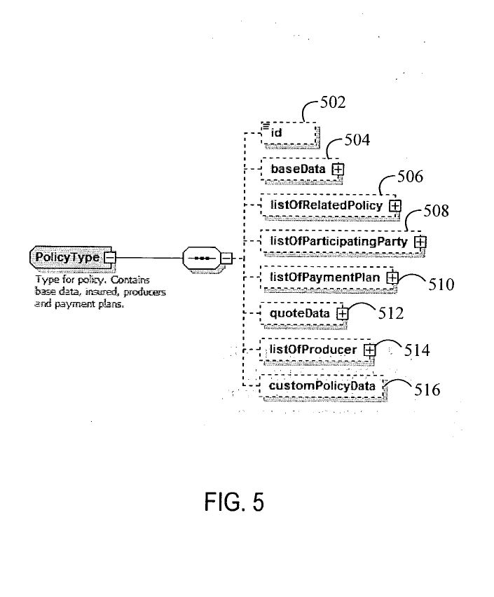

One embodiment of a common data model representing a policy will now be described in more detail in conjunction with FIGS. 5-11. One skilled in the art will appreciate that various other common data models representing an insurance product can be used with the present invention without loss of generality. In addition, the names of data elements illustrated in FIGS. 5-11 are descriptive of the information stored in the data elements.

FIG. 5 illustrates the highest level data elements of the policy class in one embodiment. The highest level data elements include id 502, baseData 504, listOfRelatedPolicy 506, listOfParticpatingParty 508, listOfPaymentPlan 510, quoteData 512, listOfProducer 514, and customPolicyData 516.

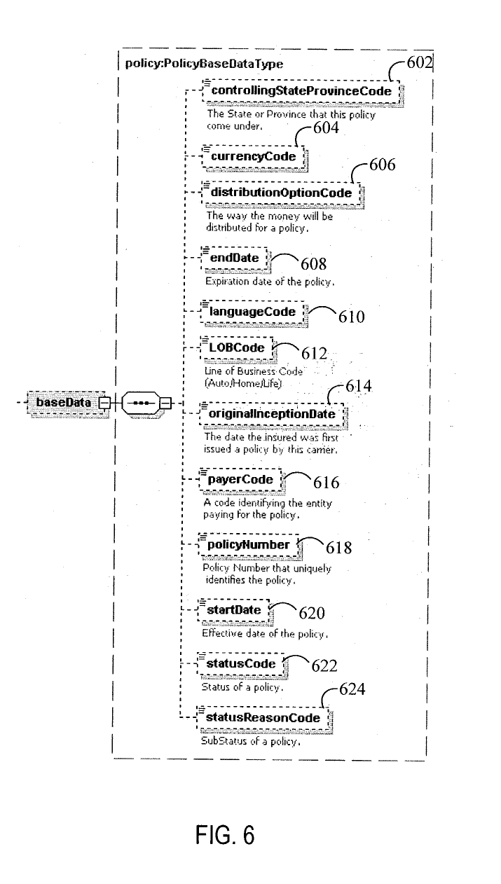

The id data element 502 may be a unique identifier of a policy. The baseData data element 504 contains general information on the policy as will be discussed in greater detail below in conjunction with FIG. 6.

The listOfRelatedPolicy data element 506 contains the list of policies that have some association with the current policy. This list may include, for example, policies that preceded the current policy and policies of parties involved in the current policy.

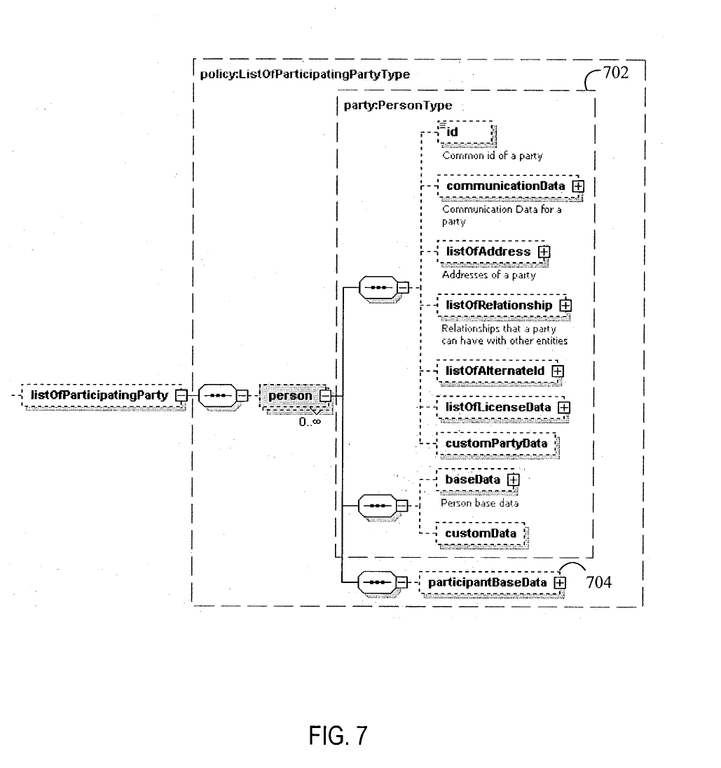

The listOfParticpatingParty data element 508 contains the list of people who are associated with the current policy (e.g., the policy insured, the benefactors, or anyone else who has an interest in the policy). The listOfParticpatingParty data element 508 will be discussed in more detail below in conjunction with FIG. 7.

The listOfPaymentPlan data element 510 contains the list of payment plans associated with the policy. For example, the insured may choose a traditional payment method via mail or an online payment method via the Internet.

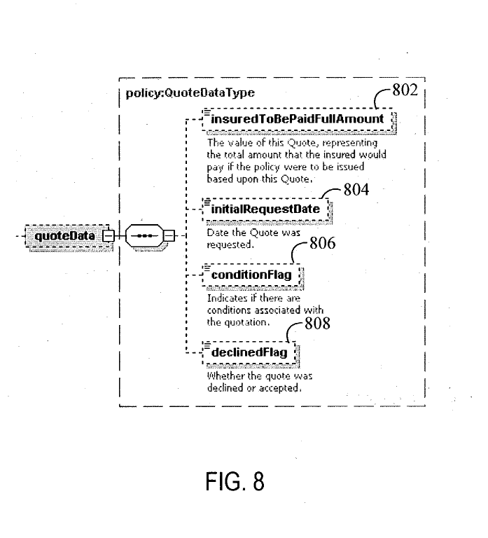

The quoteData data element 512 contains information pertaining to the policy quote as will be discussed in more detail below in conjunction with FIG. 8. According to a typical business process, a quote is specified before a policy is created. In the embodiment illustrated in FIG. 5, the quoteData data element is a component of the policy class. In some other embodiments, a quote may be represented by a separate class derived from an insurance product class.

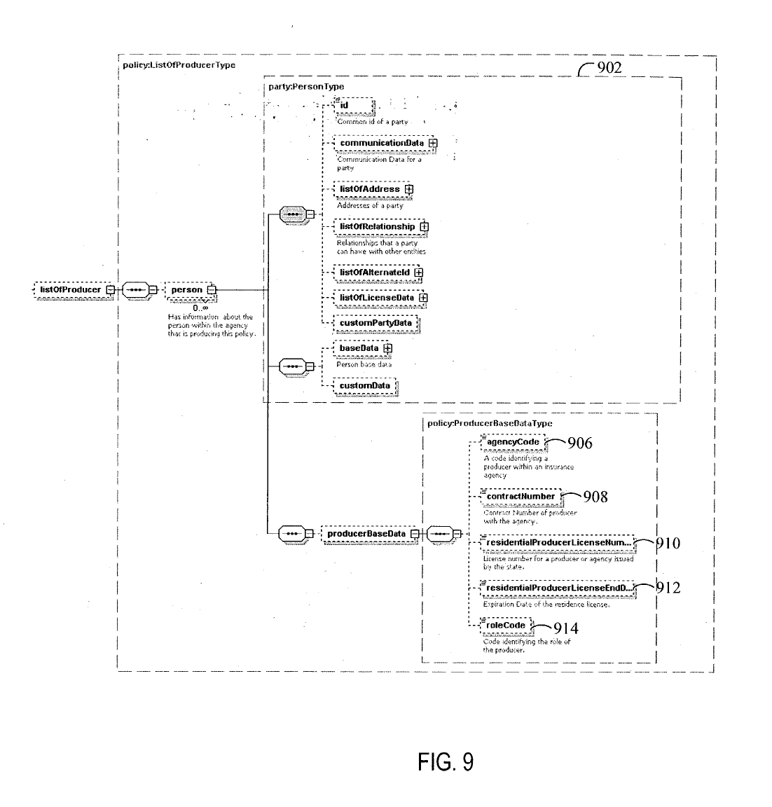

The listOfProducer data element 514 contains information on entities participating in the creation of the policy. The entities may include insurance agents, insurance brokers, employees of the insurance company, etc. The listOfProducer data element 514 will be discussed in greater detail below in conjunction with FIG. 9.

The customPolicyData data element 516 initially contains no data elements, but custom data elements can be added by defining data elements in the PolicyCustomDataType.

FIG. 6 illustrates the data elements of the baseData class in one embodiment. The data elements of the baseData class include controllingStateProvinceCode 602, currencyCode 604, distributionOptionCode 606, endDate 608, languageCode 610, LOBCode 612, originalInceptionDate 614, payerCode 616, policyNumber 618, startDate 620, statusCode 622, and statusReasonCode 624.

The controllingStateProvinceCode data element 602 contains information on the state or province that the policy comes under. The currencyCode data element 604 contains information about the currency that is used to pay the policy premium. The distributionOptionCode data element 606 specifies the way in which the money will be distributed for the policy. The endDate data element 608 defines the expiration date of the policy. The languageCode data element 610 defines the language in which the policy is written. The LOBCode data element 612 contains information on the line of business for the policy (e.g., whether the policy is an automobile policy, home policy or life policy). The originalInceptionDate data element 614 specifies when the insured was first issued a policy by this carrier. The payerCode data element 616 contains a code identifying the entity paying for the policy. The policyNumber data element 618 specifies the policy number that uniquely identifies the current policy. The startDate data element 620 specifies the effective date of the policy. The statusCode data element 622 defines the status of the policy (e.g., active, cancelled, expired, etc.). The statusReasonCode data element 624 contains information explaining the current status of the policy.

Next, as illustrated in FIG. 7, the listOfParticipatingParty class defines relationships with participating parties of different party types. The party types may include a business unit, household, organization, person, etc. FIG. 7 illustrates the data elements of the listOfParticipatingParty class for the person type. These data elements include the data elements 702 of the person class and the participantBaseData data element 704 that contains general information on the participating party (e.g., the role of the participating party in the current policy).

FIG. 8 illustrates the data elements of the QuoteData class. The data elements of the QuoteData class include insuredToBePaidFullAmount 802, initialRequestDate 804, conditionFlag 806, and declinedFlag 808.

The insuredToBePaidFullAmount data element 802 contains information on the total amount that the insured would pay if the policy were to be issued based upon the current quote. The initialRequestDate data element 804 specifies when the current quote was requested. The conditionFlag data element 806 indicates if there are conditions associated with the quotation. The declinedFlag data element 808 indicates whether the quote was declined or accepted.

Further, as illustrated in FIG. 9, the listOfProducer class defines relationships with policy producers of different party types. The party types may include a business unit, household, organization, person, etc. FIG. 9 illustrates the data elements of the listOfProducer class for the person type. These data elements include the data elements 902 of the person class and the producerBaseData data elements. The producerBaseData data elements include agencyCode 906, contractNumber 908, residentialProducerLicenseNumber 910, residentialProducerLicenseEndDate 912, and roleCode 914.

The agencyCode data element 906 specifies a code identifying a producer within an insurance agency. The contractNumber data element 908 specifies a contract number of the producer with the agency. The residentialProducerLicenseNumber data element 910 specifies a license number of a producer or agency issued by the state. The residentialProducerLicenseEndDate data element 912 specifies the expiration date of the producer's license. The roleCode data element 914 specifies a code identifying the role of the producer.

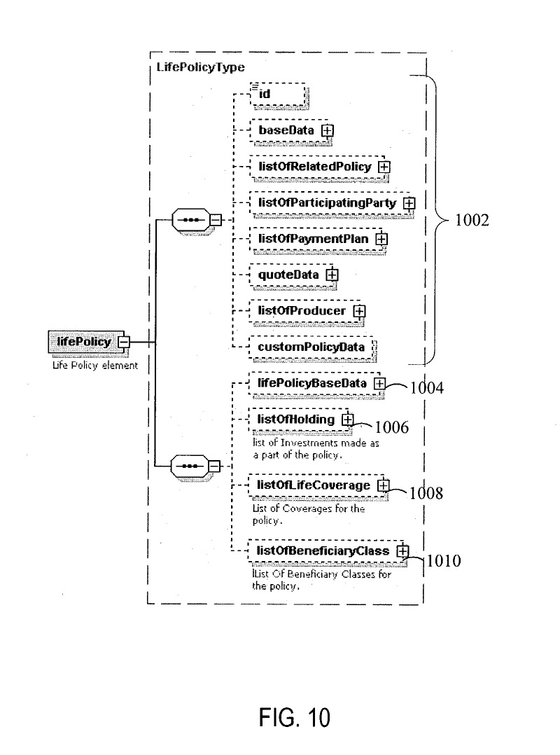

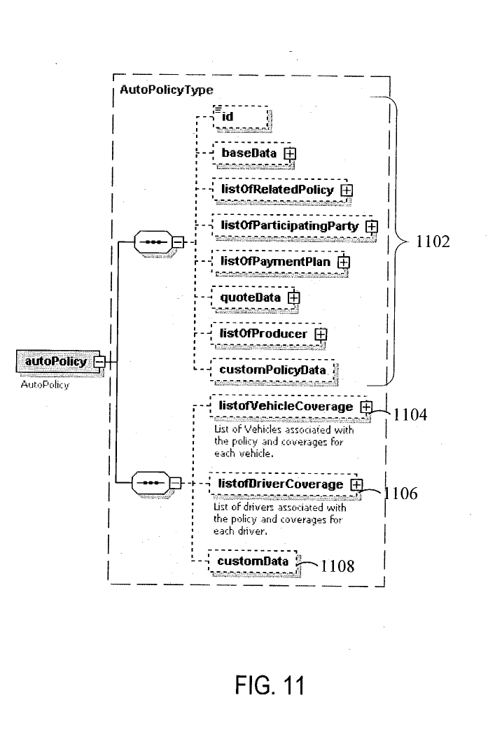

FIGS. 10 and 11 illustrate the inheritance of the policy class by the classes of the policy types. Each of these classes extends the elements of the policy class to include data elements that are specific to that class.

FIG. 10 illustrates the data elements of the life policy class in one embodiment. The life policy class inherits the data elements 1002 of the policy class and includes lifePolicyBaseData 1004, listOfHolding 1006, listOfLifeCoverage 1008, and listOfBeneficiaryClass 1010.

The lifePolicyBaseData data element 1004 includes general information on the life policy (e.g., the value of the life policy that has built up since the start date of the life policy, the face amount of the life policy, the underwriting class for the life policy, the premium to be paid annually for the life policy, etc.). The listOfHolding data element 1006 defines holdings (e.g., properties and assets) of the life policy. The listOfLifeCoverage data element 1008 defines coverages associated with the life policy. The listOfBeneficiaryClass data element 1010 defines beneficiaries of the life policy and their roles.

FIG. 11 illustrates the data elements of the auto policy class in one embodiment. The auto policy class inherits the data elements 1102 of the policy class and includes listofVehicleCoverage 1104, listofDriverCoverage 1106 and customData 1108.

The listofVehicleCoverage data element 1104 includes information on vehicles associated with the auto policy and coverages of each vehicle. The listofDriverCoverage data element 1106 includes information on coverages of each driver associated with the auto policy. The customData data element 1108 initially contains no data elements, but custom data elements can be added as discussed in more detail above.

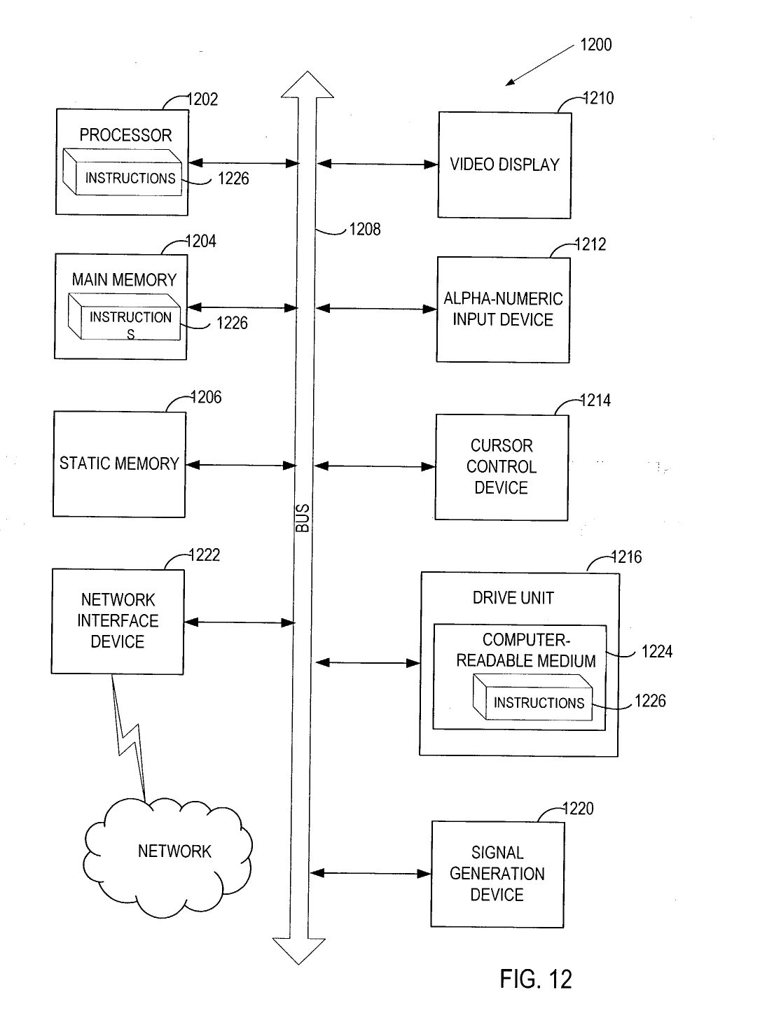

FIG. 12 is a block diagram of an exemplary computer system 1200 (e.g., of the integration server 200 of FIG. 2) that may be used to perform one or more of the operations described herein. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 1200 includes a processor 1202, a main memory 1204 and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alpha-numeric input device 1212 (e.g., a keyboard), a cursor control device 1214 (e.g., a mouse), a disk drive unit 1216, a signal generation device 1220 (e.g., a speaker) and a network interface device 1222.

The disk drive unit 1216 includes a computer-readable medium 1224 on which is stored a set of instructions (i.e., software) 1226 embodying any one, or all, of the methodologies described above. The software 1226 is also shown to reside, completely or at least partially, within the main memory 1204 and/or within the processor 1202. The software 1226 may further be transmitted or received via the network interface device 1222. For the purposes of this specification, the term “computer-readable medium” shall be taken to include any medium that is capable of storing or encoding a sequence of instructions for execution by the computer and that cause the computer to perform any one of the methodologies of the present invention. The term “computer-readable medium” shall accordingly be taken to included, but not be limited to, solid-state memories, optical and magnetic disks, and carrier wave signals.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

What is claimed is:

1. A method in a computer system for representing a class definition, the method comprising:
defining an insurance product class including a plurality of data elements that are common to a plurality of insurance product types; and
defining a plurality of derived classes that derive from the insurance product class, each of the plurality of derived classes extending the plurality of common data elements to include data elements that are specific to one of the plurality of insurance product types.

2. The method of claim 1 wherein the plurality of insurance product types comprises two or more insurance product types selected from the group consisting of an automobile insurance policy, a life insurance policy, a property insurance policy, and an insurance product quote.

3. The method of claim 1 wherein the insurance product class defines a plurality of relationships of an insurance product.

4. The method of claim 3 wherein the plurality of relationships of an insurance product is selected from the group consisting of relationships with related insurance products, relationships with parties participating in the insurance product, relationships with insurance product producers, and relationships with payment plans.

5. The method of claim 1 wherein the insurance product class includes a custom data element for defining one or more custom data fields for the insurance product class.

6. The method of claim 5 wherein the one or more custom data fields of the insurance product class are specific to an application.

7. The method of claim 1 wherein the specific data elements of each of the plurality of derived classes includes a custom data element for defining one or more data fields for said each one of the plurality of derived classes.

8. The method of claim 1 further comprising:
instantiating one of the plurality of derived classes for-a corresponding insurance product type; and
initializing data elements of the instantiated derived class.

9. The method of claim 8 further comprising:
transforming data received from a source application into a common format of said one of the plurality of the derived classes;
transforming the data from the common format into a target format of a target application; and
sending the data in the target format to the target application.

10. The method of claim 1 wherein:
one of the plurality of derived classes is an automobile insurance policy class; and
the specific data elements comprise a list of vehicles associated with an automobile insurance policy, a list of coverages for each vehicle within the list of vehicles, a list of drivers associated with the automobile insurance policy, a list of coverages for each driver within the list of drivers, and one or more custom data fields of the automobile insurance policy class.

11. The method of claim 1 wherein:
one of the plurality of derived classes is a life insurance policy class; and
the specific data elements comprise a list of holdings associated with a life insurance policy, a list of coverages associated with the life insurance policy, a list of beneficiaries of the life insurance policy, and one or more custom data fields of the life insurance policy class.

12. The method of claim 1 wherein a definition of the insurance product class is represented as an XML schema.

13. A method for data transformation, the method comprising:
receiving insurance product data from a source application;
identifying a type of the insurance product data; and
transforming the insurance product data into a common format provided by a corresponding insurance product type sub-class that is derived from an insurance product class,
wherein the insurance product class includes a plurality of data elements that are common to a plurality of insurance product types, and each insurance product type sub-class derived from the insurance product class includes the plurality of common data elements and a plurality of specific data elements that are specific to one of the plurality of insurance product types.

14. The method of claim 13 wherein the plurality of insurance product types comprises two or more insurance product types selected from the group consisting of an automobile insurance policy, a life insurance policy, a property insurance policy, and an insurance product quote.

15. The method of claim 13 wherein the insurance product class defines a plurality of relationships of an insurance product.

16. The method of claim 13 wherein the insurance product class includes a custom data element for defining one or more custom data fields for the insurance product class.

17. The method of claim 16 wherein the specific data elements of each insurance product type sub-class includes a custom data element for defining one or more data fields for said each insurance product type sub-class.

18. The method of claim 13 further comprising:
transforming the insurance product data from the common format into a target format of a target application; and
sending the insurance product data in the target format to the target application.

19. A machine-readable medium having executable instructions to cause a machine to perform a method comprising:
defining an insurance product class including a plurality of data elements that are common to a plurality of insurance product types; and
defining a plurality of derived classes that derive from the insurance product class, each of the plurality of derived classes extending the plurality of common data elements to include data elements that are specific to one of the plurality of insurance product types.

20. The machine-readable medium of claim 19 wherein the plurality of insurance product types comprises two or more insurance product types selected from the group consisting of an automobile insurance policy, a life insurance policy, a property insurance policy, and an insurance product quote.

21. The machine-readable medium of claim 19 wherein the insurance product class defines a plurality of relationships of an insurance product.

22. The machine-readable medium of claim 21 wherein the plurality of relationships of an insurance product is selected from the group consisting of relationships with related insurance products, relationships with parties participating in the insurance product, relationships with insurance product producers, and relationships with payment plans.

23. The machine-readable medium of claim 19 wherein the insurance product class includes a custom data element for defining one or more custom data fields for the insurance product class.

24. A machine-readable medium having executable instructions to cause a machine to perform a method comprising:
receiving insurance product data from a source application;
identifying a type of the insurance product data; and
transforming the insurance product data into a common format provided by a corresponding insurance product type sub-class that is derived from an insurance product class,
wherein the insurance product class includes a plurality of data elements that are common to a plurality of insurance product types, and each insurance product type sub-class derived from the insurance product class includes the plurality of common data elements and a plurality of specific data elements that are specific to one of the plurality of insurance product types.

25. The machine-readable medium of claim 24 wherein the plurality of insurance product types comprises two or more insurance product types selected from the group consisting of an automobile insurance policy, a life insurance policy, a property insurance policy, and an insurance product quote.

26. The machine-readable medium of claim 24 wherein the insurance product class defines a plurality of relationships of an insurance product.

27. The machine-readable medium of claim 24 wherein the insurance product class includes a custom data element for defining one or more custom data fields for the insurance product class.

28. A system comprising:
a memory; and
at least on processor coupled to the memory, the processor executing a set of instructions which cause the processor to
define an insurance product class including a plurality of data elements that are common to a plurality of insurance product types, and
define a plurality of derived classes that derive from the insurance product class, each of the plurality of derived classes extending the plurality of common data elements to include data elements that are specific to one of the plurality of insurance product types.

29. The system of claim 28 wherein the plurality of insurance product types comprises two or more insurance product types selected from the group consisting of an automobile insurance policy, a life insurance policy, a property insurance policy, and an insurance product quote.

30. The system of claim 28 wherein the insurance product class defines a plurality of relationships of an insurance product.

31. A system comprising:
a memory; and
at least on processor coupled to the memory, the processor executing a set of instructions which cause the processor to
receive insurance product data from a source application;
identify a type of the insurance product data; and
transform the insurance product data into a common format provided by a corresponding insurance product type sub-class that is derived from an insurance product class,
wherein the insurance product class includes a plurality of data elements that are common to a plurality of insurance product types, and each insurance product type sub-class derived from the insurance product class includes the plurality of common data elements and a plurality of specific data elements that are specific to one of the plurality of insurance product types.

32. The system of claim 31 wherein the plurality of insurance product types comprises two or more insurance product types selected from the group consisting of an automobile insurance policy, a life insurance policy, a property insurance policy, and an insurance product quote.

33. The system of claim 31 wherein the insurance product class defines a plurality of relationships of an insurance product.

34. An apparatus for representing a class definition, the apparatus comprising:
means for defining an insurance product class including a plurality of data elements that are common to a plurality of insurance product types; and
means for defining a plurality of derived classes that derive from the insurance product class, each of the plurality of derived classes extending the plurality of common data elements to include data elements that are specific to one of the plurality of insurance product types.

35. An apparatus for data transformation, the apparatus comprising:
means for receiving insurance product data from a source application;
means for identifying a type of the insurance product data; and
means for transforming the insurance product data into a common format provided by a corresponding insurance product type sub-class that is derived from an insurance product class,
wherein the insurance product class includes a-plurality of data elements that are common to a plurality of insurance product types, and each insurance product type sub-class derived from the insurance product class includes the plurality of common data elements and a plurality of specific data elements that are specific to one of the plurality of insurance product types.
